(19) United States
(12) Patent Application Publication
(10) Pub. No.: US 2013/0024039 A1
(43) Pub. Date: Jan. 24, 2013

(54) METHOD FOR BLOCKING A SWITCH

(71) Applicants: Josef Götz, Freudenberg-Aschach (DE); Thomas Kiendl, Wernberg-Koblitz (DE); Cornelia Nerl, Schwandorf (DE)

(72) Inventors: Josef Götz, Freudenberg-Aschach (DE); Thomas Kiendl, Wernberg-Koblitz (DE); Cornelia Nerl, Schwandorf (DE)

(73) Assignee: SIEMENS AKTIENGESELLSCHAFT, Munich (DE)

(21) Appl. No.: 13/553,053

(22) Filed: Jul. 19, 2012

(30) Foreign Application Priority Data
Jul. 22, 2011 (DE) 102011079652.5

(51) Int. Cl. G06F 1/26

(52) U.S. Cl. 700/292

(57) ABSTRACT

A method is disclosed for blocking a switch which is upstream when viewed from an electrical supply, downstream of which is connected a switch, wherein the switching contacts of the switches open automatically when a current threshold value is exceeded. In order to achieve a rapid detection of a short circuit in the electrical network with little outlay, in at least one embodiment it is proposed that the current is sampled, digitalized, and wavelet coefficients of at least one segmentation level are in each case calculated for a fixed specified number of immediately successive digitalized current values via a wavelet transform and compared with a wavelet threshold, and that the blocking signal is sent to the upstream switch when a specified number of immediately successive wavelet coefficients exceeds the associated wavelet threshold value in each case.

### PRIORITY STATEMENT

The present application hereby claims priority under 35 U.S.C. §119 to German patent application number DE 102011079652.5 filed Jul. 22, 2011, the entire contents of which are hereby incorporated herein by reference.

### FIELD

The invention generally relates to a method for blocking a switch which is upstream when viewed from the electrical supply.

### BACKGROUND

Electrical distribution systems with an electrical supply to which a switch arrangement is connected are known. Here, the current is distributed via the switches to the individual branches of the system. In particular, the switches are circuit breakers for the low-voltage range, which in each case are designed for a rated current and interrupt the current flowing through the switch in the event of a fault. In doing so, only that system branch which is affected by the fault must be switched off in each case, i.e. only that switch which is closest to the fault must open. This behavior is referred to as selective switch-off behavior. The switches are arranged in a graded manner in the switch arrangement of a switchgear system, wherein at least two switches are connected in series. At least each switch which is upstream when viewed from the supply has a measuring device and a trip unit, wherein, with the help of transformers, the measuring device measures the current flowing through the switch and, if necessary, also the voltage dropped at the associated system branch. An electronic trip unit, which conditions the current measured by transformers in an analog manner and subsequently digitalizes it, is used to measure both an overload current and a short-circuit current. The trip unit includes a microcontroller, which evaluates the digitalized current values (sample values) by means of appropriate calculation algorithms, and activates a magnetic actuator, for example, and switches off the switch when an overload current and a short-circuit current are detected.

In the case of switches with current-limiting characteristics, when a certain current value is exceeded, the contacts of the pole through which the current flows open in a very short time as a result of the current forces acting on the respective contact arm. In doing so, an arc which causes wear of the contacts is produced, as a result of which, in turn, the life of the switch is reduced. For this reason, it is necessary to detect and switch off a short circuit as quickly as possible.

The zone selectivity, also referred to as zone-selective interlocking, enables a selective behavior of circuit breakers with respect to one another to be achieved. In doing so, the downstream switch is connected to the immediately upstream switch by way of signals. The respective downstream switch sends a blocking signal to the upstream switch via this connection before and while it interrupts the current in order to notify the upstream switch of this. As a result of the transmitted blocking signal, the upstream switch remains closed at least for a specified delay time. The downstream circuit breaker trips if it does not receive a blocking signal from a further downstream switch within a defined time period.

For the rapid detection of a short circuit in the electrical network based on the current behavior, it is known to subject the current values to a wavelet transform and calculate the wavelet coefficients of a plurality of segmentation levels and compare them with one another. Based on the comparison, a decision is then made as to whether or not a short circuit is present.

### SUMMARY

A rapid detection of a short circuit occurs in at least one embodiment with little outlay in combination with zone-selective interlocking.

At least one embodiment provides that the current is sampled at a fixed specified sampling frequency, digitalized, and immediately successive wavelet coefficients of at least one segmentation level are in each case calculated for a fixed specified number of immediately successive digitalized current values by way of a wavelet transform and compared with a specified wavelet threshold value which is dependent on the segmentation level, and that a short circuit in the electrical network is detected and the blocking signal is sent to the upstream switch when a specified number of immediately successive wavelet coefficients of one and the same segmentation level exceed the associated wavelet threshold value in each case. Depending on which mother wavelet is used, different characteristics of the current behavior can be identified by examining the wavelet coefficients.

### BRIEF DESCRIPTION OF THE DRAWINGS

The invention is described in more detail by way of example based on an electrical distribution system in the form of a switchgear system 1.

The single FIGURE shows a schematic representation of the switchgear system 1 with switches 2, 2a.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

A plurality of switches 2, 2a is arranged in a graded manner in the switchgear system 1, wherein the current is distributed from a supply 3 via the switches 2, 2a to the individual system branches (not shown). The switches 2, 2a are circuit breakers for the low-voltage range which in each case are designed for a rated current and have an electronic trip unit with overload and short-circuit protection. A conductor of each phase is fed through each of the switches 2, 2a. When the switch 2, 2a is closed, the switching contacts of each phase rest against one another. In order to open a switch 2, 2a, its switching contacts are separated from one another by means of a switching mechanism.

Here, the switch 2 immediately after the supply 3 forms the discrimination level IV of the switchgear system 1, that is to say the IVth or highest discrimination level. The three switches 2, 2a below the discrimination level IV form the discrimination level III, the three switches 2, 2a below the discrimination level III the discrimination level II, and the three switches 2a below the discrimination level II the discrimination level I.

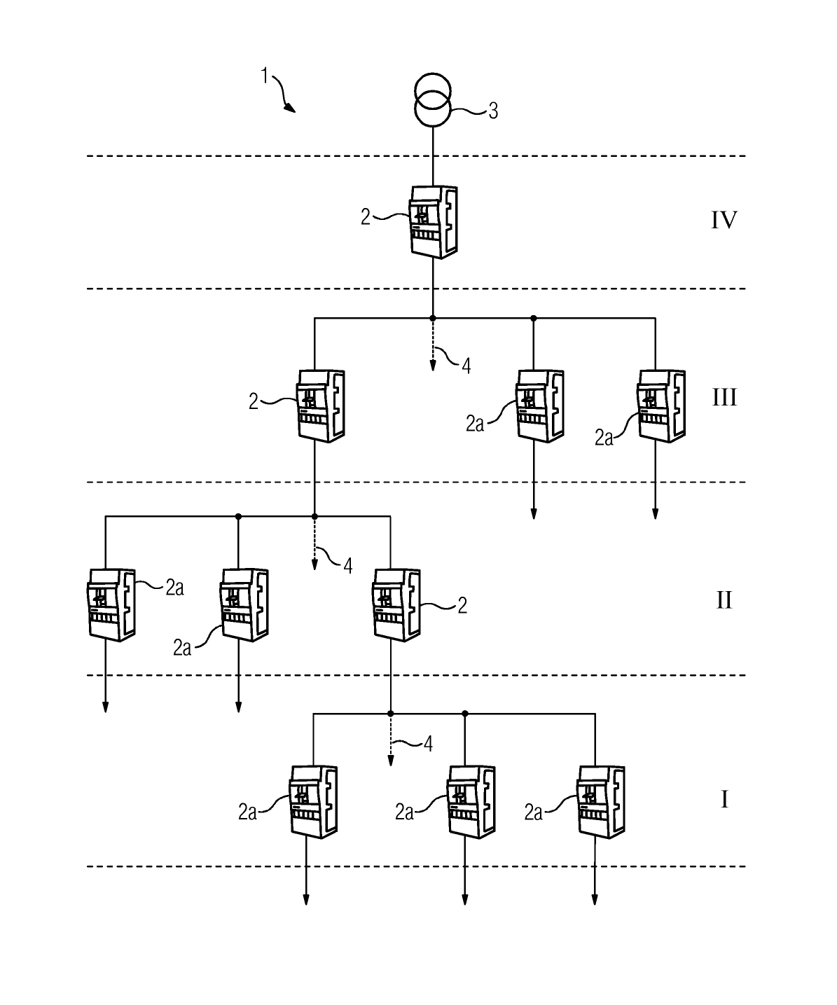

All switches which are end-of-branch switches are identified with the reference number 2a in FIG. 1. For example, the two switches 2a of discrimination level III shown on the right in the figure are end-of-branch switches, downstream of which is connected in each case a system branch as an end branch and no further switch 2. Therefore, in FIG. 1, at least one switch 2 is connected upstream of every switch 2a and no switch 2, 2a is connected downstream. Switches 2 can be connected upstream and switches 2, 2a downstream of a switch 2.

The arrows 4 point toward the system or toward a system branch in each case. Viewed from the supply 3, the current flows through the switch 2 of discrimination level IV and then through the switches 2, 2a of discrimination level III connected downstream of this switch 2. The switch 2 of discrimination level III shown on the left in FIG. 1 is connected to the three switches 2, 2a of discrimination level II, of which the two switches 2a of discrimination level II shown on the left in FIG. 1 are likewise end-of-branch switches. The switch 2 of discrimination level II shown on the right is in turn connected to the three switches 2a of discrimination level I, all three of which are end-of-branch switches.

The current which flows through a switch 2a of discrimination level I also flows through the right-hand switch 2 of discrimination level II, and the current which flows through the left-hand switch 2 of discrimination level III also flows through the switch 2 of discrimination level IV. These switches 2 are effectively connected in series. A short-circuit current in a system branch which is connected to one of the switches 2a of discrimination level I also flows through the three series-connected switches 2.

Viewed from the supply 3, the switch 2 of discrimination level IV is connected upstream of the switches 2, 2a of discrimination level III, and conversely the switches 2, 2a of discrimination level III are connected downstream of the switch 2 of discrimination level IV.

Each switch 2, 2a has an electronic trip unit with a measuring device for the current which flows through the (associated) switch 2, 2a. The current is sampled with a fixed specified sampling frequency 1/T (T is the sampling time interval) and subsequently digitalized.

Further, the electronic trip unit of each switch 2, 2a has a microcontroller.

The switches 2, 2a are current limiting, i.e. they open their contacts in a very short time when a certain current value is exceeded due to the current forces acting on their contact arms. In doing so, an arc is produced each time.

The microcontroller of each electronic trip unit is equipped with a calculation algorithm which calculates the wavelet coefficients of a least one discrimination level for a fixed specified number of immediately successive digitalized current values by means of a wavelet transform.

Here, the Haar wavelet is used as the mother wavelet; however, the Daubechies wavelet or some other suitable mother wavelet could also be considered.

The wavelet coefficients, for example of two discrimination levels (discrimination level 1 and 2), are calculated in each case from the Haar wavelet, i.e. the wavelet coefficients d1k of discrimination level 1:

d₁ₖ=(iₖ−iₖ₋₁)/\sqrt{2}

the wavelet coefficients d2k of discrimination level 2:

d₂ₖ=((iₖ+iₖ₋₁)−(iₖ₋₂+iₖ₋₃))/2

Here, ik and ik-1 represent the current sample value at time k*T and (k-1)*T respectively, where T is the sample interval time. d1k represents the wavelet coefficient of discrimination level 1 at time k*T and d2k the wavelet coefficient of discrimination level 2 at time k*T.

In principle, the wavelet coefficients of a single discrimination level or of more than two discrimination levels could also be calculated. Depending on which mother wavelet is used, different characteristics of the current signal can be identified by examining the wavelet coefficients.

The wavelet coefficients are compared with the threshold values associated with the discrimination levels, a dedicated threshold value therefore being defined for each discrimination level.

In order to achieve a certain averaging, the trip unit continuously checks whether here for example 10 (in general N, where N is an integer greater than (or equal to) 1) successive wavelet coefficients of a discrimination level exceed its threshold value. If this is the case, a short circuit is considered to be detected, i.e. a short circuit is present for the trip unit.

In parallel with this, the current values can additionally be compared with a current threshold value, and the trip unit then also detects a short circuit (additional independent condition) when a specified number of current values has exceeded the current threshold value.

Every downstream switch 2, 2a is connected to the immediately upstream switch 2 by means of signals. The downstream switch 2, 2a in each case sends a blocking signal to the upstream switch 2 by means of the connection at least when the trip unit establishes that a short circuit is present based on the wavelet coefficients or the current values. As a result of the transmitted blocking signal, the upstream switch remains closed (blocked) at least for a specified delay time.

If a short circuit is detected and the upstream switch 2 does not receive a blocking signal from a downstream switch 2, 2a within a certain (specified) time period, then the trip unit trips the switch 2 by means of a magnetic actuator.

As a result of the algorithm in combination with a connection of the electronic trip units by means of signals, it is therefore detected at an early stage whether a downstream switch 2, 2a has established a short-circuit current and is about to trip. If this switch should fail or take too long to open and therefore to extinguish the arc, then it is possible for the upstream switch 2 likewise to detect this situation quickly and to trip instead of the downstream switch 2, 2a for the purpose of backup protection.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims.

Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for blocking a switch which is upstream when viewed from an electrical supply, downstream of which in a switch arrangement for electrical distribution is connected at least one switch, current flowing through the downstream switch also flowing via the upstream switch and the upstream and the downstream switches being connected to one another via signals, the downstream switch being capable of sending a blocking signal via the connection to the upstream switch to notify the upstream switch that it or a switch which is in turn connected downstream thereof will interrupt the current, the method comprising:
sampling and digitizing the current at a fixed specified sampling frequency;
calculating immediately successive wavelet coefficients of at least one segmentation level for a fixed specified number of immediately successive digitalized current values via a wavelet transform;
comparing calculated successive wavelet coefficients with a specified wavelet threshold value which is dependent on the at least one segmentation level; and
sending the blocking signal to the upstream switch when a specified number of immediately successive wavelet coefficients of the at least one segmentation level exceeds the wavelet threshold value of the at least one segmentation level, wherein the upstream switch remains closed at least for a specified delay time as a result of the sent blocking signal.

2. The method as claimed in claim 1, wherein the wavelet transform is carried out by way of the Haar wavelet as a mother wavelet, wherein the respective wavelet coefficients (d1k)
d₁ₖ=(iₖ−iₖ₋₁)/\sqrt{2}
are calculated from the first discrimination level and the wavelet coefficients (d2k)
d₂ₖ =((iₖ+iₖ₋₁)−(iₖ₋₂+iₖ₋₃))/2
are calculated from the second discrimination level and compared with the wavelet threshold value which is associated with the respective discrimination level, where ik and ik-1 are equal to the current sample value at time k*T and (k-1)*T respectively and d1k and d2k are equal to the wavelet coefficients of the first and second discrimination level respectively at time k*T and where T is equal to the sample interval time.

3. A method, comprising:
sampling and digitizing a current of at least one switch, downstream of which is a switch which is upstream when viewed from an electrical supply, at a fixed specified sampling frequency;
calculating immediately successive wavelet coefficients of at least one segmentation level for a fixed specified number of immediately successive digitalized current values via a wavelet transform;
comparing calculated successive wavelet coefficients with a specified wavelet threshold value which is dependent on the at least one segmentation level; and
sending a blocking signal from the downstream switch to the upstream switch to notify the upstream switch that it, or a switch which is in turn connected downstream thereof, will interrupt the current when a specified number of immediately successive wavelet coefficients of the at least one segmentation level exceeds the wavelet threshold value of the at least one segmentation level, wherein the upstream switch remains closed at least for a specified delay time as a result of the sent blocking signal.

4. The method as claimed in claim 3, wherein the wavelet transform is carried out by way of the Haar wavelet as a mother wavelet,
wherein the respective wavelet coefficients (d1k)
d₁ₖ=(iₖ−iₖ₋₁)/\sqrt{2}
are calculated from the first discrimination level and the wavelet coefficients (d2k)
d₂ₖ=((iₖ+iₖ₋₁)−(iₖ₋₂+iₖ₋₃))/2
are calculated from the second discrimination level and compared with the wavelet threshold value which is associated with the respective discrimination level, where ik and ik-1 are equal to the current sample value at time k*T and (k-1)*T respectively and d1k and d2k are equal to the wavelet coefficients of the first and second discrimination level respectively at time k*T and where T is equal to the sample interval time.
